(19) United States
(12) Patent Application Publication
(10) Pub. No.: US 2005/0231442 A1
(43) Pub. Date: Oct. 20, 2005

(54) Plasma display device and driving method of plasma display panel

(76) Inventors: Sang-Chul Kim, Suwon-si (KR); Jun-Young Lee, Suwon-si (KR); Nam-Sung Jung, Suwon-si (KR); Kazuhiro Ito, Suwon-si (KR)

Correspondence Address: CHRISTIE, PARKER & HALE, LLP, PO BOX 7068, PASADENA, CA, 91109-7068, US

(21) Appl. No.: 11/107,463

(22) Filed: Apr. 14, 2005

(30) Foreign Application Priority Data
Apr. 16, 2004 (KR) 10-2004-0026174
Jun. 30, 2004 (KR) 10-2004-0050887

(51) Int. Cl. G09G 3/28

(52) U.S. Cl. 345/60

(57) ABSTRACT

Reset, address, and sustain operations of a plasma display device are performed by applying a driving waveform to a scan electrode while biasing a sustain electrode at a ground voltage. Then a driving board for driving the sustain electrode may be eliminated. In addition, a discharge between the sustain electrode and the scan electrode as well as between an address electrode and the scan electrode may be ensured in an address period by accumulating positive wall charges on the sustain electrode at an end of a falling period of a reset period.

### CROSS-REFERENCES TO RELATED APPLICATIONS

This application claims priority to and the benefit of Korean Patent Application Nos. 10-2004-0026174 and 10-2004-0050887 respectively filed in the Korean Intellectual Property Office on Apr. 16, 2004 and Jun. 30, 2004, the entire contents of which are incorporated herein by reference.

### BACKGROUND OF THE INVENTION

1. Field of the Invention

The present invention relates to a plasma display device and a driving method for a plasma display panel.

2. Description of the Related Art

A plasma display panel (PDP) is a flat panel display that uses plasma generated by gas discharge to display characters or images. Depending on its size, a PDP can have tens to millions of pixels arranged in a matrix pattern. A PDP is typically classified as either a direct current (DC) type or an alternating current (AC) type according to its discharge cell structure and the waveform of the driving voltage applied thereto.

A DC PDP has electrodes exposed to a discharge space, and accordingly, it allows a current to flow through the discharge space while a voltage is applied. Therefore, the DC PDP problematically requires a resistance for limiting the current. On the other hand, an AC PDP has electrodes covered with a dielectric layer that forms a capacitance to limit a current and protects its electrodes from the impact of ions during discharge. Accordingly, the AC PDP has a longer lifespan than the DC PDP.

FIG. 1 is a partial perspective view of an AC PDP. As shown, a PDP includes a pair of insulation substrates 1, 2 disposed apart but facing each other. A plurality of scan (Y) electrodes 3a and sustain (X) electrodes 3b are formed in parallel and by pairs on (or under) the insulation substrate 1. The scan electrodes 3a and the sustain electrodes 3b are covered with a dielectric layer 4 and a protective layer 5. A plurality of address (A) electrodes 6 are formed on the glass substrate 2 and are covered with an insulation layer 7. On the insulation layer 7, barrier ribs 8 are formed between two adjacent address electrodes 6. In addition, phosphor 9 is formed on a surface of the insulation layer 7 and on both sides of the barrier ribs 8. The insulation substrates 1, 2 are arranged facing each other with a discharge space 11 interposed therebetween such that the scan electrodes 3a and the sustain electrodes 3b lie normal (or perpendicular) to the address electrodes 6. A discharge cell (hereinafter also referred to as a cell) 12 is formed by the discharge space 11 at an intersection region of an address electrode 6 and a pair of scan electrodes 3a and sustain electrodes 3b.

In a typical AC PDP driving method, a frame of the AC PDP is divided into a plurality of subfields, and each subfield includes a reset period, an address period, and a sustain period.

The reset period is for initializing the status of each discharge cell so as to facilitate an addressing operation on the discharge cell. The address period is for selecting turn-on/turn-off cells (i.e., cells to be turned on or off) and accumulating wall charges to the turn-on cells (i.e., addressed cells). The sustain period is for causing a discharge for displaying an image on the addressed cells.

In order to perform the above-noted operations, sustain pulses are alternately applied to the scan electrodes and the sustain electrodes during the sustain period, and reset waveforms and scan waveforms are applied to the scan electrodes during the reset period and the address period. Typically, a scan driving board for driving the scan electrodes and a sustain driving board for driving the sustain electrodes are separately provided, which generates a problem of mounting the driving boards on a chassis and increases the cost.

Accordingly a method for combining the two driving boards into a single combined board, and schemes of providing the single board for an end of the scan electrodes and extending an end of the sustain electrodes to reach the combined board, have been proposed. However, when the two driving boards are combined as such, an impedance component formed at the extended sustain electrodes is increased.

### SUMMARY OF THE INVENTION

An embodiment of the present invention provides a plasma display device with a single combined board that can simultaneously drive both a scan electrode and a sustain electrode, and/or provides a driving waveform appropriate for such a combined board.

An exemplary embodiment of the present invention provides a driving method for a plasma display panel using a plurality of subfields of a frame. The plasma display panel has a plurality of first electrodes, a plurality of second electrodes, and a plurality of third electrodes crossing the first and second electrodes. In a reset period of the at least one of the subfields, the driving method includes: gradually increasing a voltage of at least one of the second electrodes from a second voltage to a third voltage while biasing at least one the first electrodes at a first voltage; and gradually decreasing the voltage of the at least one of the second electrodes from a fourth voltage to a fifth voltage while biasing the at least one of the first electrodes at the first voltage, wherein, during at least a partial period of a falling period when the voltage of the at least one of the second electrodes is decreased from the fourth voltage to the fifth voltage, a voltage of at least one of the third electrodes is biased at a sixth voltage. The sixth voltage is greater than the first voltage.

In a further embodiment, the sixth voltage is substantially equal to a voltage applied to the at least one of the third electrodes for selecting a discharge cell in an address period.

In another further embodiment, a scan pulse of a scan pulse voltage is applied to the at least one of the second electrodes in an address period while the at least one of the first electrodes is biased at the first voltage, and the fifth voltage is greater than the scan pulse voltage. In a still further embodiment, a difference between the fifth voltage and the sixth voltage is not less than the scan pulse voltage.

In yet another further embodiment, the at least partial period includes an end point of the reset period.

In yet a further embodiment, the at least one of first electrode is biased at the first voltage in an address period and a sustain period.

In one embodiment, the first voltage is a ground voltage.

In yet a further embodiment, the driving method further includes, in a sustain period: applying a seventh voltage higher than the first voltage to the at least one of the second electrodes for a sustain discharge while biasing the at least one of the first electrodes at the first voltage; and applying an eighth voltage lower than the first voltage to the at least one of the second electrodes for a sustain discharge while biasing the at least one of the first electrodes at the first voltage, wherein an absolute value of a difference between the first voltage and the seventh voltage is greater than an absolute value of a difference between the first voltage and the fourth voltage.

In one embodiment, a voltage of the at least one of the third electrodes is increased to a ninth voltage during the applying of the seventh voltage, and the voltage of the at least one of the third electrodes is maintained at a tenth voltage lower than the ninth voltage during the applying of the eighth voltage.

In still a further embodiment, the voltage of the first electrode is floated during the applying of the seventh voltage and the applying of the eighth voltage.

In still a further embodiment, the ninth voltage is equal to the sixth voltage, and the tenth voltage is equal to the first voltage.

An exemplary embodiment of the present invention includes a plasma display panel and a chassis base facing the plasma display panel. The plasma display panel has a plurality of first electrodes, a plurality of second electrodes, and a plurality of third electrodes crossing the first and second electrodes. The chassis base includes a driving board for applying a driving waveform to the second electrodes and the third electrodes so as to display an image on the plasma display panel and for biasing the first electrodes to a first voltage while the image is displayed. In a reset period of at least one subfield, the driving board gradually increases a voltage of at least one of the second electrodes from a second voltage to a third voltage and then gradually decreases a voltage of the at least one of the second electrodes from a fourth voltage to a fifth voltage, and a voltage of at least one of the third electrodes is maintained at a positive sixth voltage in at least a partial period of a falling period when the voltage of the at least one of the second electrodes is decreased to the fifth voltage.

In a further embodiment, the driving board applies a scan pulse of a scan pulse voltage to the at least one of the second electrodes, and wherein the fifth voltage is greater than the scan pulse voltage.

In another further embodiment, the at least partial period comprises an end point of the reset period.

In yet a further embodiment, the first voltage is a ground voltage.

In yet a further embodiment, the sixth voltage is substantially at a same level as a voltage applied to the at least one of the third electrodes in an address period for selecting a discharge cell.

In yet a further embodiment, the driving board alternately applies a positive seventh voltage and a negative eighth voltage to the at least one of the second electrodes for a sustain discharge in a sustain period.

In one embodiment, the driving board allows a voltage of the at least one of the third electrodes to be higher when the seventh voltage is applied to the second electrode than when the eighth voltage is applied to the second electrode.

In one embodiment, the driving board floats a voltage of the at least one of third electrodes in the sustain period.

### BRIEF DESCRIPTION OF THE DRAWINGS

FIG. 1 is a partial perspective view of a plasma display panel.

FIG. 2 is an exploded perspective view of a plasma display device according to an embodiment of the present invention.

FIG. 3 is a schematic view of a plasma display panel according to an embodiment of the present invention.

FIG. 4 is a schematic top plan view of a chassis base according to an embodiment of the present invention.

FIG. 5 is a driving waveform diagram of a plasma display panel according to a first embodiment of the present invention.

FIG. 6 is a driving waveform diagram of a plasma display panel according to a second embodiment of the present invention.

FIG. 7A and FIG. 7B illustrate wall charge states of a discharge cell for each period of FIG. 6.

FIG. 8 is a driving waveform diagram of a plasma display panel according to a third embodiment of the present invention.

FIG. 9 is a driving waveform diagram of a plasma display panel according to a fourth embodiment of the present invention.

### DETAILED DESCRIPTION

In the following detailed description, only certain exemplary embodiments of the present invention have been shown and described, by way of illustration. As those skilled in the art would realize, the described embodiments may be modified in various different ways, all without departing from the spirit or scope of the present invention. Accordingly, the drawings and description are to be regarded as illustrative in nature, and not restrictive.

Wall charges can refer to charges formed and accumulated on a wall (e.g., a dielectric layer) close to an electrode of a discharge cell. In certain embodiments, the wall charge will be described as being “formed” or “accumulated” on the electrode, although the wall charges do not actually touch the electrodes. Further, a wall voltage can refer to a potential difference formed on the wall of the discharge cell by the wall charge.

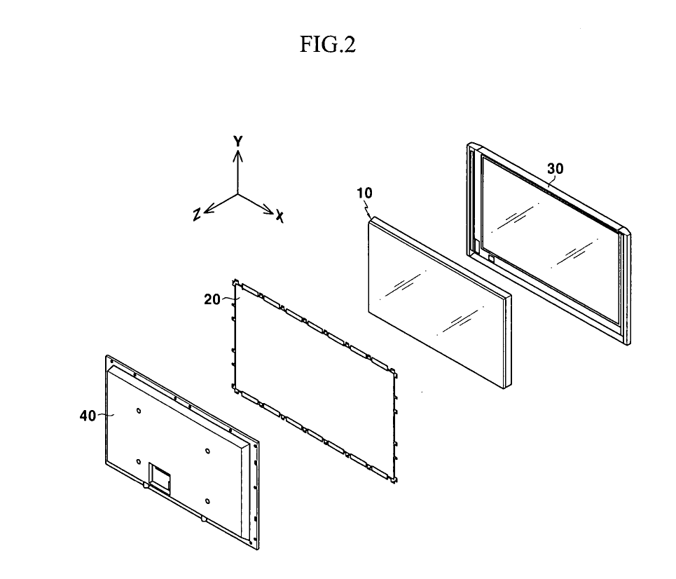

Referring to FIG. 2, a plasma display device according to an exemplary embodiment includes a plasma display panel 10, a chassis base 20, a front case 30, and a rear case 40. The chassis base 20 is combined to the plasma display panel 10 and disposed opposite to an image display side (or the front) of the plasma display panel 10. The front and rear cases 30, 40 are respectively combined to the plasma display panel 10 and the chassis base 20 to form a plasma display device. The front and rear cases 30, 40 are respectively disposed to the front of the plasma display panel 10 and the rear of the chassis base 20.

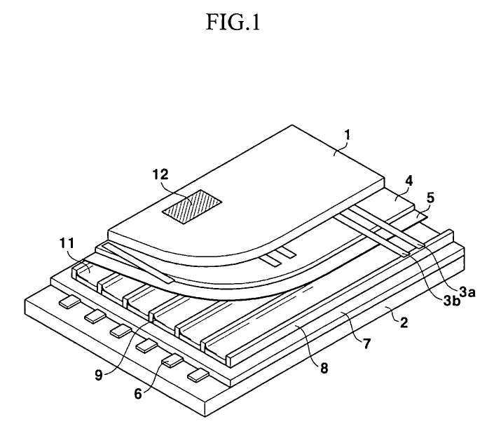

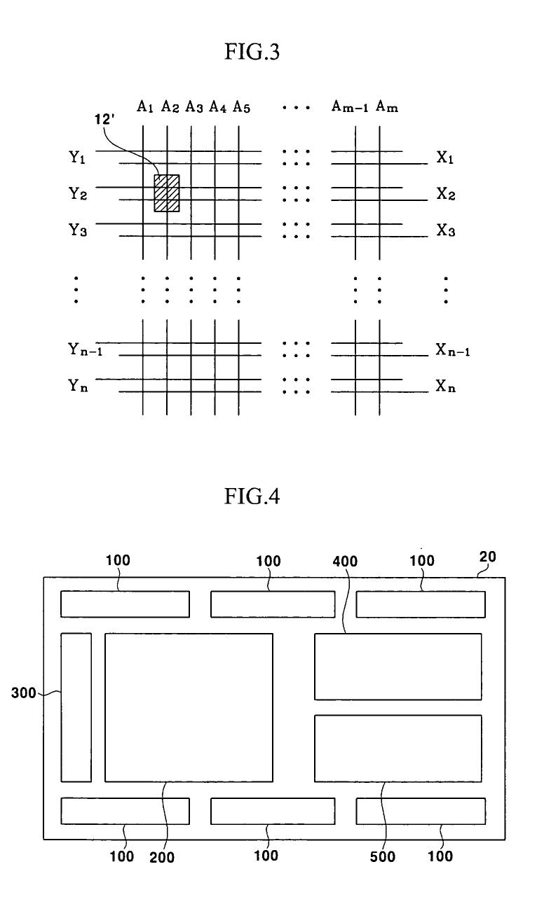

Referring to FIG. 3, the plasma display panel 10 includes a plurality of address (A) electrodes A1-Am arranged in a vertical direction and a plurality of scan (Y) electrodes Y1-Yn and sustain (X) electrodes X1-Xn each arranged in a horizontal direction. The sustain electrodes X1-Xn are formed in respective correspondence to the scan electrodes Y1-Yn, and ends of the sustain electrodes X1-Xn are connected to a common node. In addition, the plasma display panel 10 includes an insulation substrate having the sustain and scan electrodes X1-Xn, Y1-Yn formed thereon and another insulation substrate having address electrodes A1-Am formed thereon. The two insulation substrates are formed facing each other with discharge space therebetween, and the address electrodes A1-Am perpendicularly cross the scan electrodes Y1-Yn and sustain electrodes X1-Xn. A region of the discharge space where the address electrode A1-Am crosses the sustain and scan electrodes X1-Xn and Y1-Yn forms a cell 12′ that substantially corresponds to the cell 12 of FIG. 1.

As shown in FIG. 4, driving boards 100, 200, 300, 400, 500 for driving the plasma display panel 10 are formed on the chassis base 20. Address buffer boards 100, shown in upper and lower portions of the chassis base 20, may be formed as a single board or a plurality of boards. FIG. 4 exemplarily illustrates a plasma display device driven by a dual driving method. In the case of a plasma display device driven by a single driving method, the address buffer board 100 is disposed at either of the upper portion or the lower portion of the chassis base 20.

Referring still to FIG. 4, an address buffer board 100 receives an address driving control signal from an image processing and controlling board 400, and applies a voltage for selecting turn-on discharge cells (i.e., discharge cells to be turned on) to address electrodes A1-Am.

A scan driving board 200 is disposed to the left on the chassis base 20, and is coupled with the scan electrodes Y1-Yn through a scan buffer board 300. The sustain electrodes X1-Xn are biased at a predetermined voltage. The scan buffer board 300 applies a voltage to the scan electrodes Y1-Yn for sequential selection thereof during an address period. The scan driving board 200 receives driving signals from the image processing and controlling board 400, and applies the driving voltage to the scan electrodes Y1-Yn. In FIG. 4, the scan driving board 200 and the scan buffer board 300 are shown to be disposed to the left on the chassis base 20; however, they may be disposed to the right thereon. In addition, the scan buffer board 300 may be integrally formed with the scan driving board 200.

The image processing and controlling board 400 externally receives image signals, generates first control signals for driving the address electrodes A1-Am and second control signals for driving the scan and sustain electrodes Y1-Yn and X1-Xn, and respectively applies the first and second control signals to the address driving board 100 and the scan driving board 200. A power supply board 500 supplies electric power for driving the plasma display device. The image processing and controlling board 400 and the power board 500 may be located at a central area of the chassis base 20.

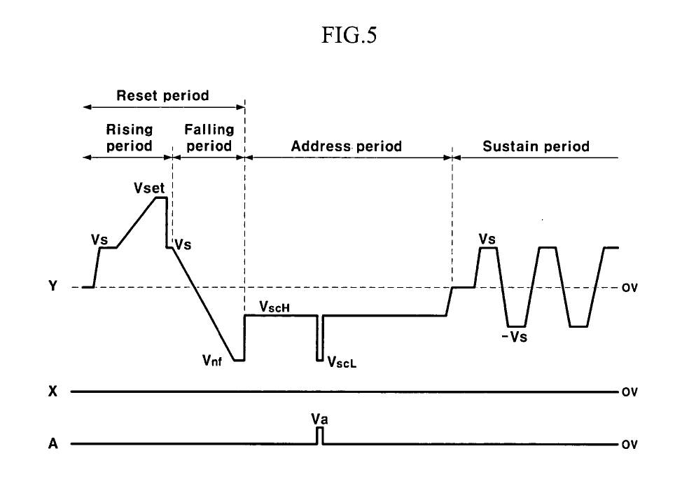

A driving waveform of a plasma display panel according to a first embodiment of the present invention will now be described with reference to FIG. 5. In the following description, the driving waveform applied to a scan electrode (hereinafter also referred to as a Y electrode), a sustain electrode (hereinafter also referred to as an X electrode) and an address electrode (hereinafter also referred to as an A electrode) is described in connection with only one cell, for better comprehension and convenience of description. Also, in the driving waveform of FIG. 5, the voltage applied to the Y electrode is supplied from the scan driving board 200 and the scan buffer board 300, and the voltage applied to the A electrode is supplied from the address buffer board 100. Since the X electrode is biased at a reference voltage (referred to as a ground or 0 voltage in FIG. 5), the voltage applied to the X voltage is not described in further detail.

Referring to FIG. 5, a subfield includes a reset period, an address period and a sustain period. The reset period includes a rising period and a falling period.

During the rising period of the reset period, the voltage of the Y electrode is gradually increased from a voltage Vs to a voltage Vset while the A electrode is maintained at the reference voltage (e.g., 0V in FIG. 5).

FIG. 5 illustrates that the voltage of the Y electrode increases according to a ramp pattern. While the voltage of the Y electrode increases, a weak discharge occurs between the Y and X electrodes and between the Y and A electrodes. Accordingly, negative (−) wall charges are formed on the Y electrode, and positive (+) wall charges are formed on the X and A electrodes. In addition, as the voltage of the Y electrode gradually changes, a weak discharge occurring in a cell forms wall charges such that a sum of an externally applied voltage and the wall charges may be maintained at a discharge firing voltage. Such a process of forming wall charges is disclosed in U.S. Pat. No. 5,745,086 by Weber.

The voltage Vset is a voltage that is set high enough to fire a discharge in each cell at any condition because every cell has to be initialized in the reset period. In addition the voltage Vs equals the voltage applied to the Y electrode in the sustain period and is lower than a voltage firing a discharge between the Y and X electrodes.

During the falling period of the reset period, the voltage of the Y electrode is gradually decreased from the voltage Vs to a negative voltage Vnf while the A electrode is maintained at the reference voltage. While the voltage of the Y electrode decreases, a weak discharge occurs between the Y and X electrodes and between the Y and A electrodes. Accordingly, the negative (−) wall charges formed on the Y electrode and the positive (+) wall charges formed on the X and A electrodes are eliminated. The voltage Vnf is usually set close to a discharge firing voltage between the Y and X electrodes. The wall voltage between the Y and X electrodes then becomes near 0V so that a discharge cell that has not experienced an address discharge in the address period may be prevented from misfiring in the sustain period. In addition, the wall voltage between the Y and A electrodes is determined by the level of the voltage Vnf, because the A electrode is maintained at the reference voltage.

Subsequently, during the address period for selection of turn-on cells, a scan pulse of a negative voltage VscL, and an address pulse of a positive voltage Va are respectively applied to Y and A electrodes of the turn-on cells. Non-selected Y electrodes are biased at a voltage VscH that is higher than the voltage VscL, and the reference voltage is applied to the A electrode of the turn-off cells (i.e., cells to be turned off). For such an operation, the scan buffer board 300 selects a Y electrode to be applied with the scan pulse VscL, among the Y electrodes Y1 to Yn. For example, in a driving method, the Y electrode may be selected according to an order of arrangement of the Y electrodes in the vertical direction. When a Y electrode is selected, the address buffer board 100 selects turn-on cells among cells formed on the selected Y electrode. That is, the address buffer board 100 selects the A electrodes among the A electrodes A1 to Am to apply the address pulse of the voltage Va.

In more detail, the scan pulse of the voltage VscL is first applied to the scan electrode of a first row (e.g., Y1 shown in FIG. 3), and at the same time, the address pulse of the voltage Va is applied to an A electrode on a turn-on cell in the first row. Then a discharge is generated between the Y electrode of the first row and the A electrode applied with the voltage Va, and accordingly, positive (+) wall charges are formed on the Y electrode and negative (−) wall charges are formed on the A and X electrodes. Because of this, a wall voltage Vwxy is formed between the X and Y electrodes such that a potential of the Y electrode becomes higher than the corresponding X electrode. Subsequently, the address pulse of the voltage Va is applied to the A electrodes of turn-on cells in a second row while the scan voltage of the voltage VscL is applied to the Y electrode in the second row (e.g., Y2 shown in FIG. 3). Then, the address discharge is generated in the cells crossed by the A electrodes applied with the voltage Va and the Y electrode in the second row, and accordingly, the wall charges are formed in such cells, in the like manner described above for the first row. Regarding Y electrodes in other rows, wall charges are formed in turn-on cells in the same manner as have been described above, i.e., by applying the address pulse of the voltage Va to the A electrodes on turn-on cells while sequentially applying a scan pulse of the voltage VscL to the Y electrodes.

In the address period, the voltage VscL is usually set equal to or less than the voltage Vnf, and the voltage Va is usually set greater than the reference voltage. Generation of the address discharge by applying the voltage Va to the A electrode is hereinafter described in connection with the case that the voltage VscL equals the voltage Vnf. When the voltage Vnf is applied in the reset period, a sum of the wall voltage between the A and Y electrodes and the external voltage Vnf between the A and Y electrodes reaches a discharge firing voltage Vfay between the A and Y electrodes. When the A electrode is applied with 0V and the Y electrode is applied with the voltage VscL(=Vnf), the discharge firing voltage Vfay is formed between the A and Y electrodes, and accordingly the discharge is expected. However, in actuality, the discharge is not generated because a discharge delay is greater than the width of the scan pulse and the address pulse. But, if the voltage Va is applied to the A electrode while the voltage VscL(=Vnf) is applied to the Y electrode, a voltage greater than the voltage Vfay is formed between the A and Y electrodes such that the discharge delay is reduced to a value that is less than the width of the scan pulse. Therefore in this case, the discharge may be generated. In one embodiment, the generation of the address discharge may be further facilitated by setting the voltage VscL to be less than the voltage Vnf.

In the sustain period, since, in the cells that have experienced an address discharge in the address period, the wall voltage Vwxy is formed such that the potential of the Y electrode is higher than the potential of the corresponding X electrode, sustain discharge is triggered between the Y and X electrodes by initially applying a pulse of the voltage Vs to the Y electrode. In this case, the voltage Vs is set such that it is lower than the discharge firing voltage Vfxy and a voltage value of Vs+Vwxy is higher than the voltage Vfxy. As a result of such a sustain discharge, negative (−) wall charges are formed on the Y electrode and positive (+) wall charges are formed on the X and A electrodes, such that the potential of the X electrode is higher than the corresponding Y electrode.

Since the wall voltage Vwxy is formed such that the potential of the Y electrode becomes higher than the potential of the corresponding X electrode, a pulse of a negative voltage −Vs is applied to the Y electrode to fire a subsequent sustain discharge. Because of this, positive (+) wall charges are formed on the Y electrode and negative (−) wall charges are formed on the X and A electrodes, such that another sustain discharge may be fired by applying the voltage Vs to the Y electrode. Subsequently, the process of alternately applying the sustain pulses of voltages Vs and −Vs to the scan electrode Y is repeated by the number corresponding to a weight value of a corresponding subfield.

As described above, reset, address, and sustain operations according to the first embodiment of the present invention may be performed by a driving waveform applied only to the Y electrode while the X electrode is biased at the reference voltage. Therefore, a driving board for driving the X electrode is not required, and the X electrode may be simply biased at the reference voltage.

However, in an address period, since an address discharge should be triggered between the A and Y electrodes and also between the X and Y electrodes, the discharge between the X and Y electrodes may not be triggered since the voltage of the X electrode is biased at the reference voltage during the address period in accordance with the first embodiment shown in FIG. 5. Because of this, the address discharge may fail because the discharge between the X and Y electrodes may not occur even if the discharge between the A and Y electrodes may have been successfully triggered. In this case, the discharge cell is not turned on in the sustain period because of the failure of the address discharge.

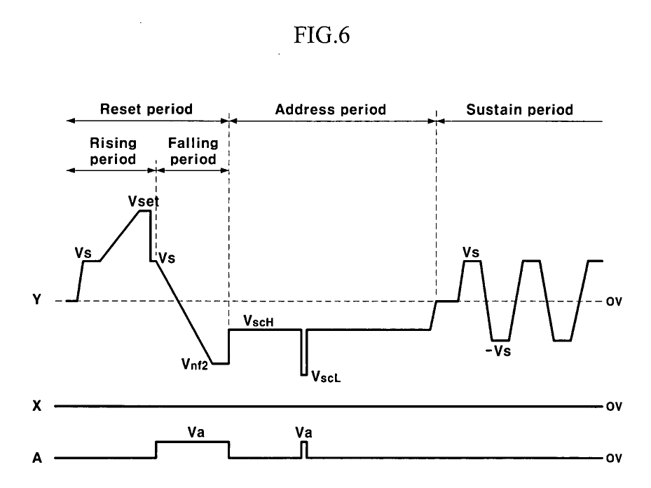

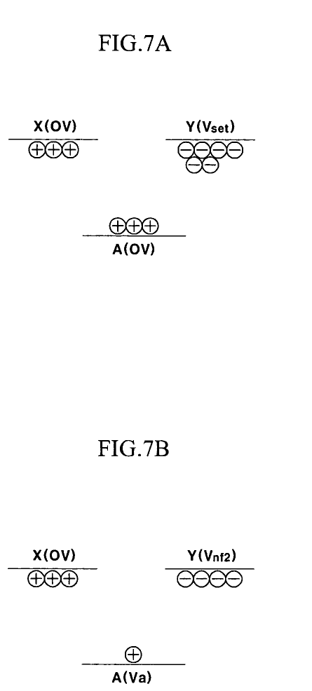

In view of the foregoing, a second embodiment of the present invention accumulates positive wall charges on the X electrode near the end of the reset period such that the discharge between the X and Y electrodes as well as between the A and Y electrode may be facilitated during the address period. The second embodiment of the present invention is described in more detail with reference to FIG. 6 and FIG. 7.

FIG. 6 is a driving waveform diagram of a plasma display panel according to the second embodiment of the present invention. FIG. 7A and FIG. 7B illustrate wall charge states of a discharge cell for each period of FIG. 6.

Referring to FIG. 6, a driving waveform according to the second embodiment of the present invention is substantially the same as in the first embodiment of the present invention, except that the A electrode is biased at a predetermined voltage during the falling period of the reset period.

In more detail, during the rising period of the reset period, the voltage of the Y electrode is gradually increased from the voltage Vs to the voltage Vset while the X and A electrodes are biased at the reference voltage. Then, a weak discharge occurs between the X and Y electrodes and between the A and Y electrodes, and accordingly, negative wall charges are accumulated on the Y electrode, and positive wall charges are accumulated on the X and A electrodes, as shown in FIG. 7A.

During the subsequent falling period of the reset period, the A electrode is biased at a predetermined voltage higher than the reference voltage, and the voltage of the Y electrode is gradually decreased from the voltage Vs to a negative voltage Vnf2 while the X electrode remains biased at the reference voltage. In this case, a voltage difference between the A and Y electrodes may be controlled so as to be the same as in the first embodiment of the present invention, e.g., by setting the voltage Vnf2 such that the difference between the voltage Vnf2 of the Y electrode and the voltage Va of the A electrode equals the voltage Vnf at the end of the reset period. In addition, an additional power voltage is not required since the same voltage Va used in the address period may be used for biasing the A electrode in the falling period.

When the voltage of the Y electrode is gradually decreased while biasing the X electrode at the reference voltage and the A electrode at the voltage Va as described above, a weak discharge occurs between the A and Y electrodes thereby partially eliminating wall charges accumulated on the A and Y electrodes. In this case, almost no discharge, or only a very weak discharge, occurs between the X and Y electrodes because the voltage difference between the X and Y electrodes is smaller than the voltage difference between the A and Y electrode, and the discharge firing voltage Vfxy between the X and Y electrodes is greater than the discharge firing voltage Vfay between the A and Y electrodes. Because of this, the wall charges on the X electrode remain at a state that is substantially the same as the state they were at in the rising period or the reset period (are negligibly reduced). That is, the reset period ends at a state when a substantial amount of positive charges is accumulated on the X electrode. Therefore, the address discharge may easily be triggered between the X and Y electrodes because the potential of the X electrode with respect to the Y electrode is higher than in the first embodiment of the present invention due to the positive wall charges accumulated on the X electrode in the address period.

According to the second embodiment of the present invention, the A electrode is biased at a positive voltage during an entire falling period of the reset period. However, the A electrode may also be biased at the positive voltage only in a partial period including an end point of the reset period.

Also, according to the second embodiment of the present invention, since the A electrode is biased at the positive voltage in the reset period, negative wall charges are accumulated on the Y electrode and positive wall charges are accumulated on the X electrode at the end of the reset period. At such a state, the address discharge occurs in the address period. Subsequently, in the sustain period, the sustain discharge occurs in discharge cells selected in the address period. Regarding cells that do not experience an address discharge in the address period, the negative wall charges that are accumulated on the Y electrode at the end of the reset period are not changed through the address period, and remain at the same state after the address period. Therefore, when the negative voltage −Vs is applied to such a Y electrode in the sustain period, misfiring may occur because a voltage difference between the Y and A electrodes may exceed the discharge firing voltage.

According to a third embodiment of the present invention, a sustain voltage pulse applied to the Y electrode is modified for preventing misfiring in the sustain period.

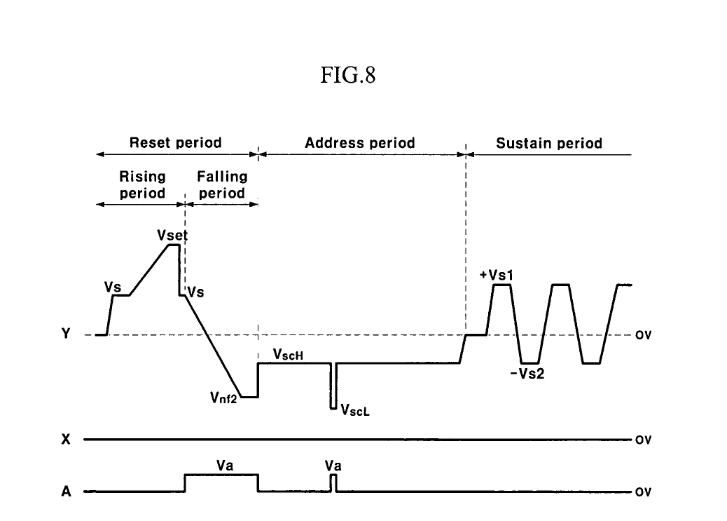

FIG. 8 is a driving waveform diagram of a plasma display panel according to the third embodiment of the present invention. As shown, pulses of voltages +Vs1 and −Vs2 are alternately applied to the Y electrode so as to generate a sustain discharge between the scan and sustain electrodes. In this case, the voltages +Vs1 and −Vs2 are set such that an absolute value of the voltage +Vs1 is higher than an absolute value of the voltage −Vs2 while a voltage difference between +Vs1 and −Vs2 remains at 2Vs. In addition, to prevent a sustain discharge from occurring in a discharge cell that is not addressed in the address period, the voltage +Vs1 is set lower than the discharge firing voltage between the sustain and scan electrodes. In addition, the voltage −Vs2 is set as a value sufficient to trigger a discharge in cooperation with the wall voltage of an addressed discharge cell.

In such a case, even if negative wall charges are accumulated on the Y electrode of a discharge cell that has not experienced the address discharge, a misfire may be prevented because a sum of the wall voltage due to the negative wall charges and the negative voltage −Vs2 applied to the Y electrode in the sustain period does not exceed the discharge firing voltage between the Y and A electrodes.

According to the third embodiment of the present invention, the positive voltage +Vs1 applied to the Y electrode in the sustain period is higher than the voltage Vs used for the sustain discharge voltage in the first and second embodiments. Because of this, when the voltage +Vs1 is applied to the Y electrode in the sustain period, misfire may occur because a voltage difference between the Y and A electrodes may exceed the discharge firing voltage.

In order to prevent such a misfire, according to a fourth embodiment of the present invention, the A electrode is floated when the voltage +Vs1 is applied to the Y electrode in the sustain period.

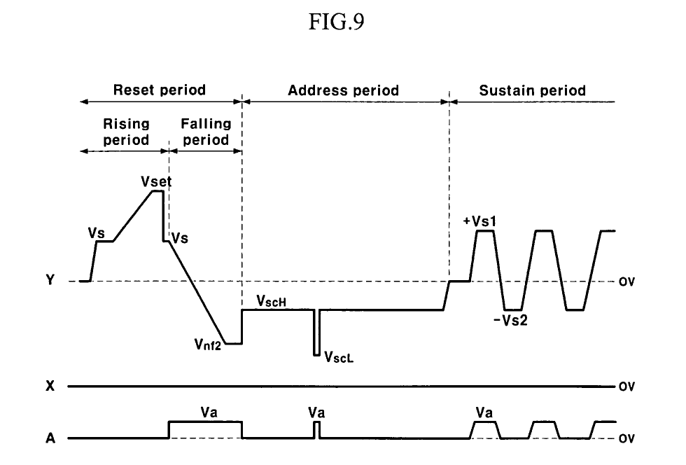

FIG. 9 is a driving waveform diagram of a plasma display panel according to a fourth embodiment of the present invention.

Similar to the third embodiment, in the fourth embodiment of the present invention, positive wall charges are accumulated on the Y (scan) electrode of a discharge cell that is not selected in the address period. However, unlike in the third embodiment, in the fourth embodiment, the voltage of the A (address) electrode is floated to the voltage Va when the voltage +Vs1 is applied to the Y electrode in the sustain period (i.e., it is not maintained at the reference voltage). Because of this, even if the voltage +Vs1 is higher than the voltage Vs, a voltage difference between the voltage of the Y electrode (i.e., a sum of a wall charge Vw1 and the applied voltage Vs1 of the Y electrode) and the voltage Va of the A electrode becomes less than the discharge firing voltage between the A and Y electrodes. Thus, a misfire may be prevented even if the voltage +Vs1, which higher than the voltage Vs, is applied to the Y electrode. In addition, when negative wall charges are accumulated on the Y electrode, a misfire does not occur between the Y and A electrodes because the voltage +Vs1 is offset by the negative wall charges and thereby the voltage of the Y electrode is lowered.

In the fourth embodiment of the present invention, the A electrode is shown to be floated only while the pulse of the voltage +Vs1 is applied to the Y electrode in the sustain period. However, the A electrode may also be floated during the entire sustain period.

As described above, according to the first through fourth embodiments of the present invention, reset, address, and sustain operations may be performed by applying a driving waveform only to the Y electrode while the X electrode is biased at a predetermined voltage. Therefore, a driving board for driving the X electrode becomes unnecessary. In addition, the paths for applying the sustain discharge pulse has uniform impedance because a pulse for a sustain discharge is supplied only from the scan driving board 300.

In general, an exemplary embodiment of the present invention has been described in connection with a case in which each of reset periods of a plurality of subfields in one frame have rising and falling periods. However, the present invention may also be applied to a case in which reset periods of some subfields have only the falling period without any rising period.

As described above, in an exemplary embodiment of the present invention, a sustain (X) electrode is biased at a predetermined voltage, and a driving waveform is only applied to the scan (Y) electrode. Therefore, a board for driving the sustain electrode may be eliminated such that a single combined board may be used for driving a display panel, thereby reducing the manufacturing cost.

In addition, according to an exemplary embodiment of the present invention, an impedance may become uniform because a pulse for a sustain discharge is supplied only from a scan driving board.

Also, according to an exemplary embodiment of the present invention, positive wall charges are accumulated on a sustain (X) electrode at an end of the falling period of a reset period, and accordingly, a discharge between the X sustain electrode and a scan (Y) electrode, as well as between an address (A) electrode and the scan (Y) electrode, may be ensured in the address period.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

1. A driving method for a plasma display panel using a plurality of subfields of a frame, the plasma display panel having a plurality of first electrodes, a plurality of second electrodes, and a plurality of third electrodes crossing the first and second electrodes, in a reset period of the at least one of the subfields, the driving method comprising:
gradually increasing a voltage of at least one of the second electrodes from a second voltage to a third voltage while biasing at least one of the first electrodes at a first voltage; and
gradually decreasing the voltage of the at least one of the second electrodes from a fourth voltage to a fifth voltage while biasing the at least one of the first electrodes at the first voltage,
wherein, during at least a partial period of a falling period when the voltage of the at least one of the second electrodes is decreased from the fourth voltage to the fifth voltage, a voltage of at least one of the third electrodes is biased at a sixth voltage,
wherein the sixth voltage is greater than the first voltage.

2. The driving method of claim 1, wherein the sixth voltage is substantially equal to a voltage applied to the at least one of the third electrodes for selecting a discharge cell in an address period.

3. The driving method of claim 1, wherein:
a scan pulse of a scan pulse voltage is applied to the at least one of the second electrodes in an address period while the at least one of the first electrodes is biased at the first voltage; and
the fifth voltage is greater than the scan pulse voltage.

4. The driving method of claim 3, wherein a difference between the fifth voltage and the sixth voltage is not less than the scan pulse voltage.

5. The driving method of claim 1, wherein the at least partial period comprises an end point of the reset period.

6. The driving method of claim 1, wherein the at least one of the first electrodes is biased at the first voltage in an address period and a sustain period.

7. The driving method of claim 6, wherein the first voltage is a ground voltage.

8. The driving method of claim 1, further comprising, in a sustain period:
applying a seventh voltage higher than the first voltage to the at least one of the second electrodes for a sustain discharge while biasing the at least one of the first electrodes at the first voltage; and
applying an eighth voltage lower than the first voltage to the at least one of the second electrodes for a sustain discharge while biasing the at least one of the first electrodes at the first voltage,
wherein an absolute value of a difference between the first voltage and the seventh voltage is greater than an absolute value of a difference between the first voltage and the fourth voltage.

9. The driving method of claim 8, wherein:
a voltage of the at least one of the third electrodes is increased to a ninth voltage during the applying of the seventh voltage; and
the voltage of the at least one of the third electrodes is maintained at a tenth voltage lower than the ninth voltage during the applying of the eighth voltage.

10. The driving method of claim 9, wherein the voltage of the first electrode is floated during the applying of the seventh voltage and the applying of the eighth voltage.

11. The driving method of claim 9, wherein the ninth voltage is equal to the sixth voltage, and the tenth voltage is equal to the first voltage.

12. A plasma display device comprising:
a plasma display panel having a plurality of first electrodes, a plurality of second electrodes, and a plurality of third electrodes crossing the first and second electrodes; and
a chassis base facing the plasma display panel and including a driving board for applying a driving waveform to the second electrodes and the third electrodes so as to display an image on the plasma display panel and for biasing the first electrodes to a first voltage while the image is displayed,
wherein, in a reset period of at least one subfield:
the driving board gradually increases a voltage of at least one of the second electrodes from a second voltage to a third voltage and then gradually decreases the at least one of the second electrodes from a fourth voltage to a fifth voltage; and
a voltage of at least one of the third electrodes is maintained at a positive sixth voltage in at least a partial period of a falling period when the voltage of the at least one of the second electrodes is decreased to the fifth voltage.

13. The plasma display device of claim 12, wherein the driving board sequentially applies a scan pulse of a scan pulse voltage to the at least one of the second electrodes, and wherein the fifth voltage is greater than the scan pulse voltage.

14. The plasma display device of claim 12, wherein the at least partial period comprises an end point of the reset period.

15. The plasma display device of claim 12, wherein the first voltage is a ground voltage.

16. The plasma display device of claim 12, wherein the sixth voltage is at a substantially same level as a voltage applied to the at least one of the third electrodes in an address period for selecting a discharge cell.

17. The plasma display device of claim 12, wherein the driving board alternately applies a positive seventh voltage and a negative eighth voltage to the at least one of the second electrodes for a sustain discharge in a sustain period.

18. The plasma display device of claim 17, wherein the driving board allows a voltage of the at least one of the third electrodes to reach a first level when the positive seventh voltage is applied to the at least one of the second electrodes and to reach a second level when the eighth voltage is applied to the second electrode, and wherein the first level is greater than the second level.

19. The plasma display device of claim 17, wherein the driving board floats a voltage of the at least one of the third electrodes in the sustain period.

20. A plasma display panel in a reset period of at least one subfield comprising:
means for gradually increasing a voltage of a scan electrode from a second voltage to a third voltage in a reset period of at least one subfield while biasing a sustain electrode at a first voltage;
means for gradually decreasing the voltage of the scan electrode from a fourth voltage to a fifth voltage in the reset period of the at least one subfield while biasing the sustain electrode at a first voltage; and
means for biasing an address electrode at a sixth voltage when the voltage of the scan electrode is decreased from the fourth voltage to the fifth voltage,
wherein the sixth voltage is greater than the first voltage.
